(19) United States
(12) Patent Application Publication
(10) Pub. No.: US 2024/0178556 A1
(43) Pub. Date: May 30, 2024

(54) Electronic Device

(71) Applicant: Huawei Technologies Co., Ltd., Shenzhen (CN)

(72) Inventors: Dawei Zhou, Shenzhen (CN); Yuanpeng Li, Shenzhen (CN); Hanyang Wang, Reading (GB); Jian Luo, Shenzhen (CN)

(21) Appl. No.: 18/551,733

(22) PCT Filed: Mar. 21, 2022
(86) PCT No.: PCT/CN2022/082025

§ 371 Date: Sep. 21, 2023

(30) Foreign Application Priority Data
Mar. 23, 2021 (CN) 202110309406.8

(51) Int. Cl. H01Q 1/36; H01Q 1/48; H01Q 1/50; H01Q 5/314; H01Q 13/10

(52) U.S. Cl. CPC H01Q 1/36; H01Q 1/48; H01Q 1/50; H01Q 5/314; H01Q 13/10

(57) ABSTRACT

An electronic device includes: a ground, a frame, and an antenna structure. The antenna structure includes a radiator and a first capacitive component. The frame has a first location and a second location. The frame between the first location and the second location is the radiator of the antenna structure. A first slot is configured at the first location of the frame. The first capacitive component is electrically coupled between the first location of the frame and a first end of the radiator, or the first capacitive component is electrically coupled between a first end of the radiator and the ground. The first end of the radiator is an end that is of the radiator and that is at the first slot.

This application claims priority to Chinese Patent Application No. 202110309406.8, filed with the China National Intellectual Property Administration on Mar. 23, 2021 and entitled “ELECTRONIC DEVICE”, which is incorporated herein by reference in its entirety.

### TECHNICAL FIELD

This application relates to the field of wireless communication, and in particular, to an electronic device.

### BACKGROUND

Currently, a screen-to-body ratio of an electronic device generally becomes larger, and correspondingly, a size of an antenna clearance (including a projection clearance and a 3D clearance) becomes smaller. If a same antenna design is used in the electronic device, radiation efficiency of an antenna decreases as a clearance of the antenna decreases. In this case, currently, the electronic device keeps an over-the-air (over-the-air, OTA) standard unchanged for the antenna, and even has a higher requirement for some frequency bands. With a given OTA index, an OTA decrease caused by a decrease in the radiation efficiency of the antenna can be compensated by improving conduction power and sensitivity of radio frequency. However, cost of the conduction power and sensitivity improvement is high, and improvement space is limited. Therefore, it is particularly important to find a method for improving antenna radiation efficiency in a very small antenna clearance environment for an electronic device (for example, a full-screen mobile phone) with a screen-to-body ratio.

### SUMMARY

Embodiments of this application provide an electronic device, including a new antenna structure. A capacitor is connected in a conventional antenna structure in series, so that the antenna structure is no longer sensitive to a dielectric loss change of a dielectric layer, and higher radiation efficiency can be obtained by using a same antenna solution in a same antenna space environment.

According to a first aspect, an electronic device is provided, including a ground, a frame, and an antenna structure. The antenna structure includes a radiator and a first capacitive component. The frame has a first location and a second location. The frame between the first location and the second location is used as the radiator of the antenna structure. A first slot is configured at the first location of the frame. The first capacitive component is electrically connected between the first location of the frame and a first end of the radiator, or the first capacitive component is electrically connected between a first end of the radiator and the ground. The first end of the radiator is an end that is of the radiator and that is at the first slot.

According to the technical solution in this embodiment of this application, a slot is configured at an end of the radiator, and a capacitor is disposed at the slot. The capacitor may be a lumped capacitor component, or an equivalent capacitor in various distribution forms. When the radiator resonates, a magnetic field formed between the radiator and the ground is evenly distributed and has a greater amplitude than that in the conventional technology in the same solution. Because the magnetic field formed by the new antenna structure is evenly distributed and has a greater amplitude, when radiation generated by the radiator passes through plastic particles (a dielectric), a dielectric loss of the dielectric has very little impact on the radiation. From a perspective of radiation efficiency of the antenna structure, the dielectric loss of the plastic particles has very little impact on the antenna structure. Therefore, the antenna structure can obtain higher radiation efficiency.

With reference to the first aspect, in some implementations of the first aspect, an operating frequency band of the antenna structure covers 698 MHz to 960 MHz, and a capacitance value of the first capacitive component is between 1.5 pF and 15 pF; or an operating frequency band of the antenna structure covers 1710 MHz to 2170 MHz, and a capacitance value of the first capacitive component is between 1.5 pF and 2 pF; or an operating frequency band of the antenna structure covers 2300 MHz to 2690 MHz, and a capacitance value of the first capacitive component is between 0.3 pF and 10 pF.

According to the technical solution in this embodiment of this application, a size of a radiator may be adjusted to change an operating frequency band of the antenna structure. For example, the operating frequency band may cover some frequency bands in a GPS system, such as an L1 (1575.42 MHz±1.023 MHz) frequency band, an L2 (1227.60 MHz±1.023 MHz) frequency band, or an L5 (1176.45 MHz±1.023 MHz) frequency band in the GPS system. Alternatively, the operating frequency band may cover an N77 (3.3 GHz to 4.2 GHz) frequency band and an N79 (4.4 GHz to 5.0 GHz) frequency band in a 5G frequency band.

With reference to the first aspect, in some implementations of the first aspect, the electronic device further includes a feed unit. A second slot is configured at the second location of the frame. A first feed point is disposed at a second end of the radiator. The second end of the radiator is an end that is of the radiator and that is at the second slot. The feed unit is electrically connected to the first feed point of the radiator.

According to the technical solution in this embodiment of this application, the electronic device may be used in an inverted L antenna.

With reference to the first aspect, in some implementations of the first aspect, the electronic device further includes a feed unit. The radiator is connected to the second location of the frame. A first feed point is disposed at a second end of the radiator. The second end of the radiator is an end that is of the radiator and that is at the second location. The feed unit is electrically connected to the first feed point of the radiator.

According to the technical solution in this embodiment of this application, the electronic device may be used in an inverted F antenna.

With reference to the first aspect, in some implementations of the first aspect, the electronic device further includes a second capacitive component. A third slot is provided on the radiator The third slot is located between the first feed point and the first slot. The second capacitive component is connected to the radiator in series at the third slot.

According to the technical solution in this embodiment of this application, a plurality of series-connected capacitors are additionally disposed on the antenna radiator, so that more equivalent inductors of the radiator can be canceled, and an antenna environment at a tail end of the radiator is changed. Therefore, a magnetic field between the radiator and the ground is more evenly distributed, an amplitude of the magnetic field is larger, near-field electric field strength of the antenna structure is smaller, and radiation absorbed by plastic particles at a dielectric layer is less. This can further improve radiation efficiency of the antenna structure.

With reference to the first aspect, in some implementations of the first aspect, radiator parts on two sides of the third slot have a same length.

According to the technical solution in this embodiment of this application, the radiator may be divided into a plurality of parts by using the slots provided on the radiator. Lengths of the radiator parts may be equal, or may be unequal. This does not affect the technical solution provided in this application, and may be adjusted based on an actual design or production requirement.

With reference to the first aspect, in some implementations of the first aspect, the electronic device further includes a feed unit and a second capacitive component. A second slot is configured at the second location of the frame. The second capacitive component is electrically connected between the second location of the frame and a second end of the radiator, or the second capacitive component is electrically connected between a second end of the radiator and the ground. The second end of the radiator is an end that is of the radiator and that is at the second slot. The radiator includes a first radiator and a second radiator, and an end part of the first radiator and an end part of the second radiator are opposite to, but do not contact each other. A third slot is formed between the end part of the first radiator and the end part of the second radiator. A first feed point is disposed at an end that is of the first radiator and that is at the third slot. A second feed point is disposed at an end that is of the second radiator and that is at the third slot. The feed unit is electrically connected to the first feed point and the second feed point of the radiator. Electrical signals of the feed unit at the first feed point and the second feed point have a same amplitude but inverse phases.

According to the technical solution in this embodiment of this application, the electronic device may be used in an electric dipole antenna.

With reference to the first aspect, in some implementations of the first aspect, the electronic device further includes a third capacitive component and a fourth capacitive component. A fourth slot and a fifth slot are provided on the radiator. The fourth slot is located between the first feed point and the first slot, and the fifth slot is located between the second feed point and the second slot. The third capacitive component is connected to the first radiator in series at the fourth slot. The fourth capacitive component is connected to the second radiator in series at the fifth slot.

According to the technical solution in this embodiment of this application, a plurality of series-connected capacitors are additionally disposed on the antenna radiator, so that more equivalent inductors of the radiator can be canceled, and an antenna environment at a tail end of the radiator is changed. Therefore, a magnetic field between the radiator and the ground is more evenly distributed, an amplitude of the magnetic field is larger, near-field electric field strength of the antenna structure is smaller, and radiation absorbed by plastic particles at a dielectric layer is less. This can further improve radiation efficiency of the antenna structure.

With reference to the first aspect, in some implementations of the first aspect, the third slot, the fourth slot, and the fifth slot are distributed at equal spacings on the radiator.

According to the technical solution in this embodiment of this application, the radiator may be divided into a plurality of parts by using the slots provided on the radiator. Lengths of the radiator parts may be equal, or may be unequal. This does not affect the technical solution provided in this application, and may be adjusted based on an actual design or production requirement.

With reference to the first aspect, in some implementations of the first aspect, the first end of the radiator is a radiator section that is on the radiator and that includes a first endpoint. The first endpoint is an endpoint that is of the radiator and that is at the first slot. An electrical length of the radiator section is within one eighth of a first wavelength. The first wavelength is a wavelength corresponding to the operating frequency band of the antenna structure.

According to the technical solution in this embodiment of this application, the first end of the radiator cannot be understood as a point in a narrow sense, and may also be considered as a radiator section that includes the first endpoint (an endpoint that is of the radiator and that is at the first slot) on the radiator.

With reference to the first aspect, in some implementations of the first aspect, the electronic device further includes a dielectric layer. The dielectric layer is disposed between the radiator and the ground.

According to the technical solution in this embodiment of this application, the dielectric layer may be disposed between the radiator and the ground, to improve strength of the antenna structure.

With reference to the first aspect, in some implementations of the first aspect, a first magnetic field between the radiator and the ground when the antenna structure including the radiator and the first capacitive component works is distributed more evenly than a second magnetic field between the radiator and the ground when the antenna structure from which the first capacitive component is removed works.

With reference to the first aspect, in some implementations of the first aspect, a first current on the radiator when the antenna structure including the radiator and the first capacitive component works is distributed more evenly than a second current between the radiator and the ground when the antenna structure from which the first capacitive component is removed works.

According to the technical solution in this embodiment of this application, the radiator may be equivalent to an inductor. A capacitor is connected at a tail end of the radiator in series, so that the equivalent inductor of the radiator can be canceled, and an antenna environment at the tail end of the radiator is changed. In this case, the tail end of the radiator is still a strong point of a magnetic field. In other words, a magnetic field between the radiator and the ground is evenly distributed and an amplitude of the magnetic field increases, and a corresponding electric field is evenly distributed and an amplitude of the electric field decreases. Therefore, for the antenna structure provided in this embodiment of this application, near-field electric field strength of the antenna structure is reduced and even, and radiation absorbed by plastic particles at a dielectric layer is reduced. Because impact of a dielectric loss of the plastic particles on radiation efficiency is reduced, radiation efficiency of the antenna structure can be effectively improved.

According to a second aspect, an electronic device is provided, including: a ground, a frame, a feed unit, and an antenna structure. The antenna structure includes a radiator and a first capacitive component. The frame has a first location and a second location. The frame between the first location and the second location is used as the radiator of the antenna structure. The radiator is connected to the first location of the frame. A first feed point is disposed on the radiator. The feed unit is electrically connected to the first feed point of the radiator. A first slot is provided on the radiator, and the first slot is located between the first feed point and the first location. The first capacitive component is connected to the radiator in series at the first slot.

With reference to the second aspect, in some implementations of the second aspect, an operating frequency band of the antenna structure covers 698 MHz to 960 MHz, and a capacitance value of the first capacitive component is between 1.5 pF and 15 pF; or an operating frequency band of the antenna structure covers 1710 MHz to 2170 MHz, and a capacitance value of the first capacitive component is between 1.5 pF and 2 pF; or an operating frequency band of the antenna structure covers 2300 MHz to 269 MHz, and a capacitance value of the first capacitive component is between 0.3 pF and 10 pF.

With reference to the second aspect, in some implementations of the second aspect, a second slot is configured at the second location of the frame. The first feed point is disposed at a first end of the radiator. The first end of the radiator is an end that is of the radiator and that is at the second slot.

With reference to the second aspect, in some implementations of the second aspect, the electronic device further includes a second capacitive component. A third slot is provided on the radiator. The third slot is located between the first feed point and the first slot. The second capacitive component is connected to the radiator in series at the third slot.

With reference to the second aspect, in some implementations of the second aspect, the first slot and the third slot are distributed at equal spacings on the radiator.

With reference to the second aspect, in some implementations of the second aspect, the radiator is connected to the second location of the frame. The radiator includes a first radiator and a second radiator. An end part of the first radiator and an end part of the second radiator are opposite to, but do not contact each other, and a second slot is formed between the end part of the first radiator and the end part of the second radiator. The first feed point is disposed at an end that is of the second radiator and that is at the second slot. A second feed point is disposed at an end that is of the second radiator and that is at the second slot. The feed unit is electrically connected to the first feed point and the second feed point of the radiator. Electrical signals of the feed unit at the first feed point and the second feed point have a same amplitude but inverse phases.

With reference to the second aspect, in some implementations of the second aspect, the electronic device further includes a second capacitive component. A third slot is provided on the radiator, and the third slot is located between the second feed point and the second location. The second capacitive component is connected to the radiator in series at the third slot.

With reference to the second aspect, in some implementations of the second aspect, the first slot, the second slot, and the third slot are distributed at equal spacings on the radiator.

With reference to the second aspect, in some implementations of the second aspect, the electronic device further includes a dielectric layer. The dielectric layer is disposed between the radiator and the ground.

With reference to the second aspect, in some implementations of the second aspect, a first magnetic field between the radiator and the ground when the antenna structure including the radiator and the first capacitive component works is distributed more evenly than a second magnetic field between the radiator and the ground when the antenna structure from which the first capacitive component is removed works.

With reference to the second aspect, in some implementations of the second aspect, a first current on the radiator when the antenna structure including the radiator and the first capacitive component works is distributed more evenly than a second current between the radiator and the ground when the antenna structure from which the first capacitive component is removed works.

### BRIEF DESCRIPTION OF DRAWINGS

FIG. 1 is a schematic diagram of an electronic device according to an embodiment of this application;

FIG. 2 is a schematic diagram of a structure of an inverted L antenna in the conventional technology:

FIG. 3 is radiation efficiency corresponding to different DF values of the antenna structure shown in FIG. 2;

FIG. 4 is a schematic diagram of a structure of an inverted F antenna in the conventional technology:

FIG. 5 is radiation efficiency corresponding to different DF values of the antenna structure shown in FIG. 4;

FIG. 6 is a schematic diagram of a structure of an electric dipole antenna in the conventional technology;

FIG. 7 is radiation efficiency corresponding to different DF values of the antenna structure shown in FIG. 6:

FIG. 8 is a schematic diagram of a structure of a composite right and left hand antenna in the conventional technology;

FIG. 9 is radiation efficiency corresponding to different DF values of the antenna structure shown in FIG. 8;

FIG. 10 is a schematic diagram of a structure of a slot antenna in the conventional technology;

FIG. 11 is radiation efficiency corresponding to different DF values of the antenna structure shown in FIG. 10;

FIG. 12 is a schematic diagram of an electronic device 10 according to an embodiment of this application:

FIG. 13 is a schematic diagram of a structure of another electronic device according to an embodiment of this application;

FIG. 14 is a diagram of a simulation result of radiation efficiency of an antenna structure shown in FIG. 12;

FIG. 15 is a diagram of a simulation result of a magnetic field of the antenna structure shown in FIG. 12;

FIG. 16 is a diagram of a simulation result of current distribution of the antenna structure shown in FIG. 12;

FIG. 17 is a schematic diagram of an electronic device 10 according to an embodiment of this application;

FIG. 18 is a schematic diagram of a structure of another electronic device according to an embodiment of this application;

FIG. 19 is a schematic diagram of a structure of another electronic device according to an embodiment of this application:

FIG. 20 is a diagram of a simulation result of radiation efficiency of antenna structures shown in FIG. 12, and FIG. 17 to FIG. 19:

FIG. 21 is a diagram of a simulation result of a magnetic field of the antenna structure shown in FIG. 19:

FIG. 22 is a diagram of a simulation result of radiation efficiency of the antenna structure shown in FIG. 19;

FIG. 23 is a schematic diagram of a structure of an electronic device according to an embodiment of this application:

FIG. 24 is a schematic diagram of a structure of another electronic device according to an embodiment of this application;

FIG. 25 is a schematic diagram of a structure of another electronic device according to an embodiment of this application;

FIG. 26 is a diagram of a simulation result of radiation efficiency of antenna structures shown in FIG. 24 and FIG. 25;

FIG. 27 is a schematic diagram of a structure of another electronic device according to an embodiment of this application;

FIG. 28 is a schematic diagram of a structure of another electronic device according to an embodiment of this application;

FIG. 29 is a diagram of a simulation result of radiation efficiency of antenna structures shown in FIG. 27 and FIG. 28;

FIG. 30 is a schematic diagram of a structure of another electronic device according to an embodiment of this application:

FIG. 31 is a schematic diagram of a structure of another electronic device according to an embodiment of this application;

FIG. 32 is a diagram of a simulation result of radiation efficiency of antenna structures shown in FIG. 30 and FIG. 31;

FIG. 33 is a schematic diagram of a structure of another electronic device according to an embodiment of this application;

FIG. 34 is a schematic diagram of a structure of another electronic device according to an embodiment of this application;

FIG. 35 is a diagram of a simulation result of radiation efficiency of antenna structures shown in FIG. 33 and FIG. 34; and

FIG. 36 is a schematic diagram of another antenna structure according to an embodiment of this application.

### DESCRIPTION OF EMBODIMENTS

The following describes technical solutions of this application with reference to accompanying drawings.

It should be understood that, in this application, an “electrical connection” may be understood as physical contact and electrical conduction of components. It may also be understood as a form in which different components in a line structure are connected through physical lines that can transmit an electrical signal, such as a printed circuit board (printed circuit board, PCB) copper foil or a conducting wire. A “communication connection” may refer to an electrical signal transmission, including a wireless communication connection and a wired communication connection. The wireless communication connection does not require a physical medium and does not belong to a connection relationship that defines a construction of a product. Both “connection” and “interconnection” may refer to a mechanical connection relationship or a physical connection relationship. For example, A-B connection or A-B interconnection may refer to that a fastened component (for example, a screw, a bolt, or a rivet) exists between A and B; or A and B contact each other, and are difficult to be separated.

The technical solutions provided in this application are applicable to an electronic device that uses one or more of the following communication technologies: a Bluetooth (blue tooth, BT) communication technology, a global positioning system (global positioning system, GPS) communication technology, a wireless fidelity (wireless fidelity, Wi-Fi) communication technology, a global system for mobile communication (global system for mobile communication, GSM) communication technology, a wideband code division multiple access (wideband code division multiple access, WCDMA) communication technology, a long term evolution (long term evolution, LTE) communication technology, a 5G communication technology, and other future communication technologies. The electronic device in embodiments of this application may be a mobile phone, a tablet computer, a laptop computer, a smart band, a smart watch, a smart helmet, smart glasses, or the like. Alternatively, the electronic device may be a cellular phone, a cordless phone, a session initiation protocol (session initiation protocol, SIP) phone, a wireless local loop (wireless local loop, WLL) station, a personal digital assistant (personal digital assistant, PDA), a handheld device with a wireless communication function, a computing device or another processing device connected to a wireless modem, a vehicle-mounted device, an electronic device in a 5G network, an electronic device in a future evolved public land mobile network (public land mobile network, PLMN), or the like. This is not limited in embodiments of this application.

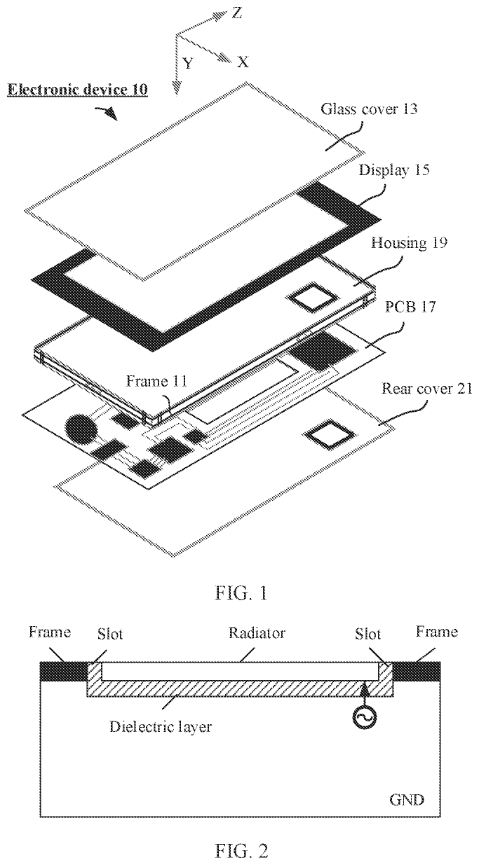

FIG. 1 shows an example of an internal environment of an electronic device according to this application. An example in which the electronic device is a mobile phone is used for description.

As shown in FIG. 1, an electronic device 10 may include a cover glass (cover glass) 13, a display (display) 15, a printed circuit board (printed circuit board, PCB) 17, a housing (housing) 19, and a rear cover (rear cover) 21.

The glass cover 13 may be disposed close to the display 15, and may be mainly used to protect the display 15 against dust.

In an embodiment, the display 15 may be a liquid crystal display (liquid crystal display, LCD), a light-emitting diode (light-emitting diode, LED), an organic light-emitting diode (organic light-emitting diode, OLED), or the like. This is not limited in this application.

The printed circuit board PCB 17 may be a flame-resistant material (FR-4) dielectric board, or may be a Rogers (Rogers) dielectric board, or may be a hybrid dielectric board of Rogers and FR-4, or the like. Herein. FR-4 is a grade designation for a flame-resistant material, and the Rogers dielectric board is a high-frequency board. A metal layer may be disposed on a side that is of the printed circuit board PCB 17 and that is close to the housing 19, and the metal layer may be formed by etching metal on a surface of the PCB 17. The metal layer may be used for grounding an electronic component carried on the printed circuit board PCB 17, to prevent an electric shock of a user or damage to a device. The metal layer may be referred to as a PCB ground. Not limited to the PCB ground, the electronic device 10 may alternatively have another ground for grounding, for example, a metal housing or another metal plane in the electronic device.

The electronic device 10 may alternatively include a battery, which is not shown herein. The battery may be disposed in the housing 19, the battery may divide the PCB 17 into a main board and a sub-board, the main board may be disposed between the housing 19 and an upper edge of the battery, and the sub-board may be disposed between the housing 19 and a lower edge of the battery.

The housing 19 is mainly used to support the electronic device 10. The housing 19 may include a frame 11, and the frame 11 may be made of a conductive material like metal. The frame 11 may extend around a periphery of the electronic device 10 and the display 15, and the frame 11 may specifically surround four sides of the display 15, to help fasten the display 15. In an implementation, the frame 11 made of the metal material may be directly used as a metal frame of the electronic device 10, to form an appearance of the metal frame, and is applicable to a metal ID (industrial design). In another implementation, an outer surface of the frame 11 may alternatively be made of a non-metal material, for example, a plastic frame, to form an appearance of the non-metal frame, and is applicable to a non-metal ID.

The rear cover 21 may be a rear cover made of a metal material, or may be a rear cover made of a non-conductive material, for example, a glass rear cover, a plastic rear cover, or another non-metal rear cover.

FIG. 1 shows only an example of some components included in the electronic device 10. Actual shapes, actual sizes, and actual construction of these components are not limited to those shown FIG. 1.

FIG. 2 is a schematic diagram of a structure of an inverted L antenna (inverted L antenna, ILA) in the conventional technology.

As shown in FIG. 2, a section of a frame of an electronic device is used as a radiator of the ILA, a slot is formed between each of two ends of the radiator and the frame, and a feed unit performs feeding at an end of the radiator. A dielectric layer including plastic particles is disposed between the radiator and a ground (ground, GND), and may be implemented by using a nano molding technology (nano molding technology, NMT). The plastic particles are dielectric materials, and two important electrical parameters of the plastic particles are respectively a dielectric constant (dielectric constant. DK) and a dielectric dissipation factor (dissipation factor. DF). The dielectric layer including the plastic particles may be used as a support for the radiator as an antenna support.

It should be understood that an antenna structure of the electronic device generally includes the radiator, and may further include at least a part of the ground of the electronic device, and/or a feed source, and/or a dielectric layer closely connected to the radiator. The ground may be a PCB, a housing, or another metal layer of the electronic device. This is not limited in this application.

In the antenna structure shown in FIG. 2, for the plastic particles of the dielectric layer, a DK value is 3.5, and a DF value is 0.05 (a working frequency is 1.5 GHz). Generally, a plurality of electronic components (such as a screen) in the electronic device may absorb radiation generated by an antenna, and consequently, radiation efficiency is reduced. Therefore, the DF value of 0.05 is used herein, and is a result of fitting a loss of an electronic component around the antenna structure. In antenna structural diagrams and simulation diagrams in FIG. 2 to FIG. 11, a size of the used ground is 74 mm×151 mm×5 mm. Details are not described in the following again. The size is used only for simulation comparison, and may be adjusted based on an actual production or design requirement.

It should be understood that, the radiator of the ILA at a resonance frequency is equivalent to an antenna element with a quarter operating wavelength formed to stimulate the ground of the electronic device to generate radiation at the resonance frequency.

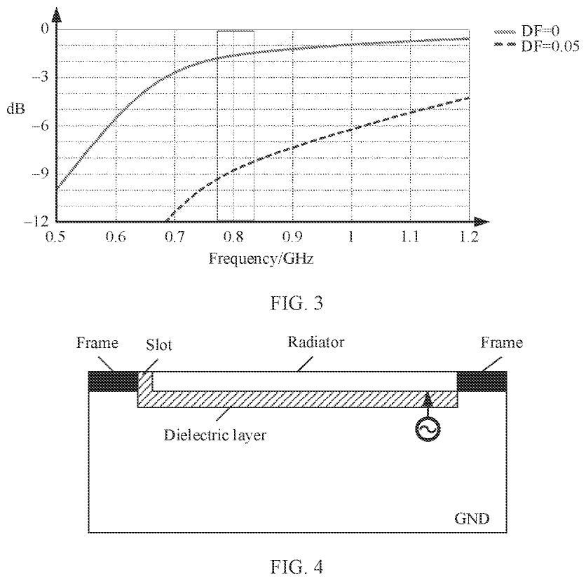

FIG. 3 is radiation efficiency (radiation efficiency) corresponding to different DF values of the antenna structure shown in FIG. 2.

It should be understood that the ILA uses a low frequency as an operating frequency band in an antenna design, and specifically, a frequency of 0.8 GHz. In both the antenna structural diagrams and the simulation diagrams in FIG. 2 to FIG. 11, 0.8 GHz is used as an operating frequency band. Details are not described in the following again.

As shown in FIG. 3, two radiation efficiency curves are respectively radiation efficiency curves when the plastic particles at the dielectric layer have same DK values and have DF values of 0.05 and 0 respectively. In other words, the two radiation efficiency curves indicate comparison between a case in which the plastic particles have a dielectric loss (the DF value is 0.05) and a case in which the plastic particles have no dielectric loss (the DF value is 0). It can be learned through comparison that when the plastic particles have no dielectric loss, the radiation efficiency of the antenna structure is significantly improved, for example, is improved by 7 dB at 0.8 GHz.

It should be understood that, for a same ILA structure, in a same antenna clearance environment, a dielectric loss of the plastic particles at the dielectric layer in the antenna structure may reduce radiation efficiency.

FIG. 4 is a schematic diagram of a structure of an inverted F antenna (inverted F antenna, IFA) in the conventional technology.

As shown in FIG. 4, a section of a frame of an electronic device is used as a radiator of an IFA, one end of the radiator is connected to the frame, and a slot is formed between the other end of the radiator and the frame. A feed unit performs feeding at the end that is of the radiator and that is connected to the frame. A dielectric layer including plastic particles is disposed between the radiator and a ground, and may be implemented by using an NMT.

It should be understood that, the radiator of the IFA at a resonance frequency is equivalent to an antenna element with a quarter operating wavelength formed to stimulate the ground of the electronic device to generate radiation at the resonance frequency.

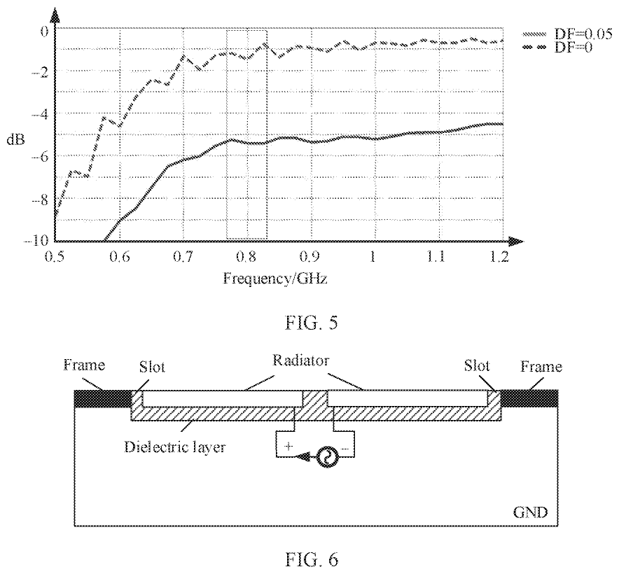

FIG. 5 is radiation efficiency corresponding to different DF values of the antenna structure shown in FIG. 4.

As shown in FIG. 5, two radiation efficiency curves are respectively radiation efficiency curves when the plastic particles at the dielectric layer have same DK values and have DF values of 0.05 and 0 respectively. In other words, the two radiation efficiency curves indicate comparison between a case in which the plastic particles have a dielectric loss and a case in which the plastic particles have no dielectric loss. It can be learned through comparison that when the plastic particles have no dielectric loss, the radiation efficiency of the antenna structure is significantly improved, for example, is improved by 4 dB at 0.8 GHz.

It should be understood that, for a same IFA structure, in a same antenna clearance environment, a dielectric loss of the plastic particles at the dielectric layer in the antenna structure may reduce radiation efficiency.

FIG. 6 is a schematic diagram of a structure of an electric dipole (electric dipole) antenna in the conventional technology.

As shown in FIG. 6, a section of a frame of an electronic device is used as two radiators of the electric dipole antenna, ends of the two radiators are opposite to, but do not contact each other, and the other ends of the two radiators separately form a slot with the frame. A feed unit performs anti-symmetrical feeding (anti-symmetrical feeding) at the opposite ends of the two radiators. A dielectric layer including plastic particles is disposed between the radiator and a ground, and may be implemented by using an NMT.

It should be understood that the anti-symmetrical feeding may be understood as that positive and negative poles of the feed unit are respectively connected to two ends of the radiator. Signals output from the positive and negative poles of the feed unit have a same amplitude but inverse phases (for example, a phase difference is 180°±10°). The radiator of the electric dipole antenna at a resonance frequency is equivalent to an antenna element with a half operating wavelength formed to stimulate the ground of the electronic device to generate radiation at the resonance frequency.

FIG. 7 is radiation efficiency corresponding to different DF values of the antenna structure shown in FIG. 6.

As shown in FIG. 7, two radiation efficiency curves are respectively radiation efficiency curves when the plastic particles at the dielectric layer have same DK values and have DF values of 0.05 and 0 respectively. In other words, the two radiation efficiency curves indicate comparison between a case in which the plastic particles have a dielectric loss and a case in which the plastic particles have no dielectric loss. It can be learned through comparison that when the plastic particles have no dielectric loss, the radiation efficiency of the antenna structure is significantly improved, for example, is improved by 9 dB at 0.8 GHz.

It should be understood that, for a same electric dipole antenna structure, in a same antenna clearance environment, a dielectric loss of the plastic particles at the dielectric layer in the antenna structure may reduce radiation efficiency.

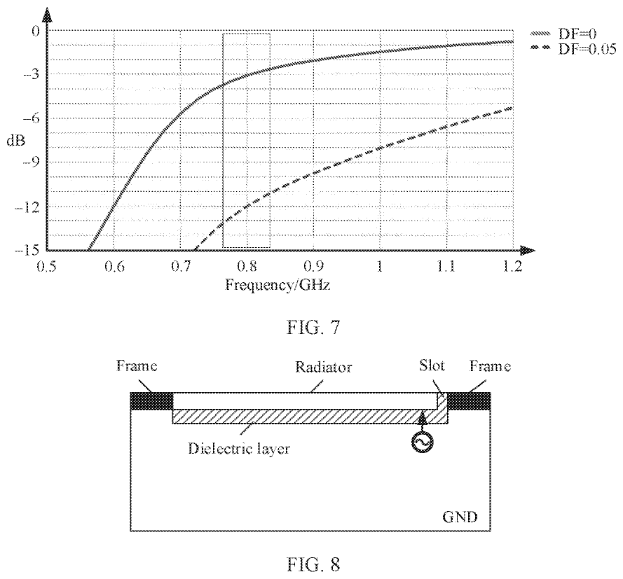

FIG. 8 is a schematic diagram of a structure of a composite right and left hand (composite right and left hand, CRLH) antenna in the conventional technology.

As shown in FIG. 8, a section of a frame of an electronic device is used as a radiator of the composite right and left hand antenna, one end of the radiator is connected to the frame, and a slot is formed between the other end of the radiator and the frame. A feed unit performs feeding at the end that is of the radiator and that forms the slot with the frame. A dielectric layer including plastic particles is disposed between the radiator and a ground, and may be implemented by using an NMT.

It should be understood that, the radiator of the composite right and left hand antenna at a resonance frequency is equivalent to an antenna element with a quarter operating wavelength formed to stimulate the ground of the electronic device to generate radiation at a frequency less than the resonance frequency.

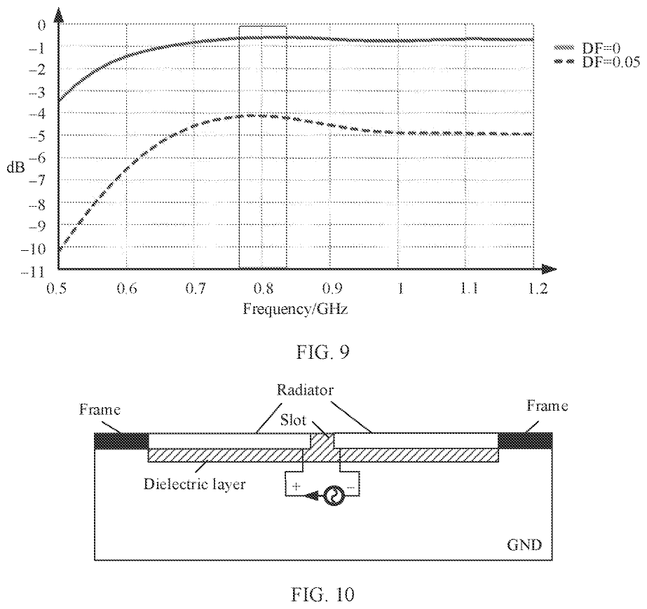

FIG. 9 is radiation efficiency corresponding to different DF values of the antenna structure shown in FIG. 8.

As shown in FIG. 9, two radiation efficiency curves are respectively radiation efficiency curves when the plastic particles at the dielectric layer have same DK values and have DF values of 0.05 and 0 respectively. In other words, the two radiation efficiency curves indicate comparison between a case in which the plastic particles have a dielectric loss and a case in which the plastic particles have no dielectric loss. It can be learned through comparison that when the plastic particles have no dielectric loss, the radiation efficiency of the antenna structure is significantly improved, for example, is improved by 3 dB at 0.8 GHz.

It should be understood that, for a same composite right and left hand antenna structure, in a same antenna clearance environment, a dielectric loss of the plastic particles at the dielectric layer in the antenna structure may reduce radiation efficiency.

FIG. 10 is a schematic diagram of a structure of a slot (slot) antenna in the conventional technology.

As shown in FIG. 10, a section of a frame of an electronic device is used as two radiators of the slot antenna. Ends of the two radiators are opposite to, but do not contact each other, and form a slot. The other ends of the two radiators are separately connected to the frame. A feed unit performs anti-symmetrical feeding at the opposite ends of the two radiators. A dielectric layer including plastic particles is disposed between the radiator and a ground, and may be implemented by using an NMT.

It should be understood that, the radiator of the slot antenna at a resonance frequency is equivalent to an antenna element with a half operating wavelength formed to stimulate the ground of the electronic device to generate radiation at the resonance frequency.

FIG. 11 is radiation efficiency corresponding to different DF values of the antenna structure shown in FIG. 10.

As shown in FIG. 11, two radiation efficiency curves are respectively radiation efficiency curves when the plastic particles at the dielectric layer have same DK values and have DF values of 0.05 and 0 respectively. In other words, the two radiation efficiency curves indicate comparison between a case in which the plastic particles have a dielectric loss and a case in which the plastic particles have no dielectric loss. It can be learned through comparison that when the plastic particles have no dielectric loss, the radiation efficiency of the antenna structure is significantly improved, for example, is improved by 2 dB at 0.8 GHz.

It should be understood that, for a same slot antenna structure, in a same antenna clearance environment, a dielectric loss of the plastic particles at the dielectric layer in the antenna structure may reduce radiation efficiency.

The foregoing antenna structures are all common antenna structures in the electronic device. For an antenna in the electronic device, a slot formed between the antenna and the frame or the housing needs to be filled by using plastic particles, so that the radiator is fastened in the electronic device. In this case, the antenna and the frame or the housing form a complete mechanical part. In a given antenna clearance environment, the antenna radiation efficiency is reduced due to the dielectric loss of plastic particles for the same antenna structure. Specifically, in an extremely small antenna space environment, the dielectric loss of the plastic particles may be understood as that near-field electric fields of the antenna structure are partially absorbed. For different antenna solutions, stronger and more concentrated electric field strength of the antenna structure indicates greater impact on the dielectric loss of the plastic particles. The dielectric layer including the plastic particles is indispensable to the antenna structure. Therefore, in a same antenna clearance environment, radiation efficiency of an antenna needs to be improved in case of a same dielectric loss of the plastic particles or a larger dielectric loss of the plastic particles.

This application provides a new antenna structure, so that higher radiation efficiency can be obtained by using a same antenna solution in a same antenna space environment.

In simulation experiment in this embodiment of this application, a size of a used ground is 74 mm×151 mm×5 mm. Details are not described in the following embodiments again. The size is used only for simulation comparison, and may be adjusted based on an actual production or design requirement.

It should be understood that an ILA uses a low frequency as an operating frequency band in an antenna design, and specifically, a frequency of 0.8 GHz. In this embodiment provided in this application, 0.8 GHz is used as an operating frequency band. Details are not described in the following embodiments again.

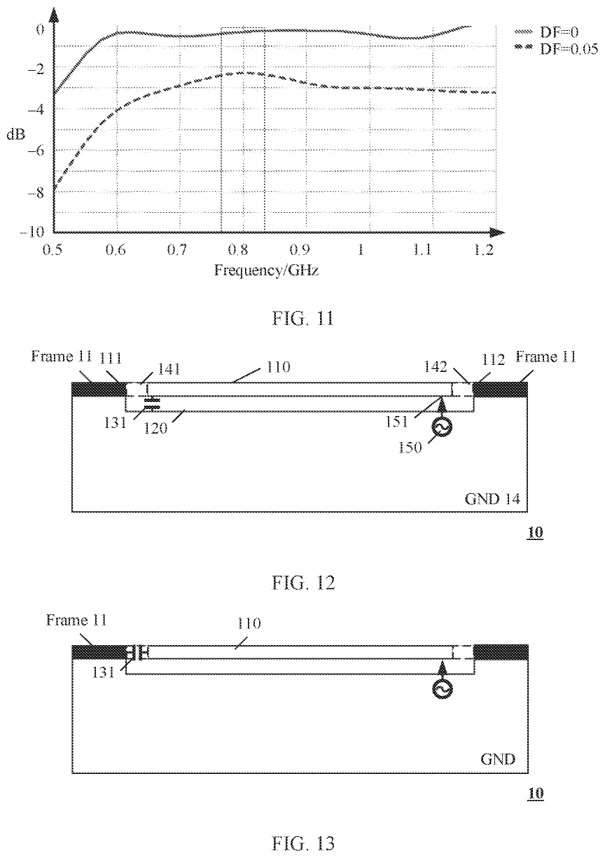

FIG. 12 is a schematic diagram of an electronic device 10 according to an embodiment of this application.

As shown in FIG. 12, the electronic device 10 may include a frame 11, a ground 14, and an antenna structure. The antenna structure may include a radiator 110 and a first capacitive component 131.

The frame 11 has a first location 111 and a second location 112, and the frame between the first location 111 and the second location 112 is used as the radiator 110 of the antenna structure. A first slot 141 is configured at the first location 111 of the frame 11. The first capacitive component 131 is electrically connected between a first end of the radiator 110 and the ground 14 (the first end of the radiator 110 is an end that is of the radiator 110 and that is at the first slot 141). “Electrically connected between . . . ” may be understood as that the first capacitive component 131 is connected between the first end of the radiator 110 and the ground 14 in series.

In an embodiment, the electronic device 10 may further include a dielectric layer 120, and the dielectric layer 120 may be disposed between the radiator 110 and the ground 14, to improve strength of the antenna structure.

In an embodiment, the ground 14 may be electrically connected to the frame 11, so that potentials of the ground 14 and the frame 11 are the same, to ensure good isolation between the antenna structure provided in this embodiment of this application and another antenna structure in the electronic device.

In an embodiment, because the frame 11 is electrically connected to the ground 14, the first capacitive component 131 may also be electrically connected between the first end of the radiator 110 and the first location 111. As shown in FIG. 13, same technical effect as that of the electronic device shown in FIG. 12 may also be obtained.

It should be understood that, according to the new antenna structure provided in this embodiment of this application, the antenna structure includes the radiator and the first capacitive component. The antenna structure may further include a part of the ground in the electronic device, and the ground may be a metal layer or a PCB (Printed Circuit Board, printed circuit board) in the electronic device. A slot is configured at an end of the radiator, and a capacitive component is connected in series at the slot. The capacitive component may be a lumped capacitor component, or may be one or more other components equivalent to a capacitor. In this case, a capacitance value of the one or more other components is a capacitance value of an equivalent capacitor of the one or more other components, for example, an equivalent capacitor in various distribution forms, or may be another capacitive component or circuit. This is not limited in this application. When the radiator resonates, a magnetic field formed between the radiator and the ground in this embodiment of this application is distributed more evenly, and has a greater amplitude than that in the conventional technology in which a capacitive component is not connected in series. It may alternatively be understood that when the antenna structure works, a first magnetic field between the radiator and the ground is distributed more evenly than a second magnetic field between the radiator and the ground when the antenna structure from which the first capacitive component is removed works. Because the magnetic field formed by the new antenna structure is evenly distributed and has a greater amplitude, when radiation generated by the radiator passes through plastic particles (a dielectric, for example, the dielectric layer 20), a dielectric loss of the dielectric has very little impact on the radiation. From a perspective of radiation efficiency of the antenna structure, the dielectric loss of the plastic particles has very little impact on the antenna structure. Therefore, the antenna structure can obtain higher radiation efficiency.

In an embodiment, the first end of the radiator 110 cannot be understood as a point in a narrow sense, and may also be considered as a radiator section that includes a first endpoint (an endpoint that is of the radiator 110 and that is at the first slot 141) on the radiator 110. For example, the first end of the radiator 110 may be considered as a radiator section whose distance from the first endpoint is within a range of one eighth of a first wavelength. The first wavelength may be a wavelength corresponding to an operating frequency band of the antenna structure, or may be a wavelength corresponding to a center frequency of an operating frequency band, or a wavelength corresponding to a resonance point.

In an embodiment, the radiator antenna structure shown in FIG. 12 may work at a low frequency (for example, 0.8 GHz), and/or an intermediate frequency (for example, a GPS frequency band), and/or a high frequency (for example, a 5G frequency band). A capacitance value of the first capacitive component 131 is between 0.3 pF and 15 pF. A specific capacitance value may be adjusted based on an actual design or production requirement to meet a requirement.

In an embodiment, the electronic device 10 may further include a feed unit 150. As shown in FIG. 12, a second slot 142 is configured at the second location 112 of the frame 11. A feed point 151 is disposed at a second end (the second end of the radiator 110 is an end that is of the radiator 110 and that is at the second slot 142) of the radiator 110. The feed unit 150 is electrically connected to the radiator 110 at the feed point 151, to perform feeding for the antenna structure. In this embodiment, the radiator antenna structure forms an ILA antenna.

In an embodiment, the second end of the radiator 110 cannot be understood as a point in a narrow sense, and may also be considered as a radiator section that includes a second endpoint (an endpoint that is of the radiator 110 and that is at the second slot 142, or an endpoint that is of the radiator 110 and that is connected to the second location of the frame) on the radiator 110. For example, the second end of the radiator 110 may be considered as a radiator section whose distance from the second endpoint is within a range of one eighth of a second wavelength. The first wavelength may be a wavelength corresponding to an operating frequency band of the antenna structure, or may be a wavelength corresponding to a center frequency of an operating frequency band, or a wavelength corresponding to a resonance point.

In an embodiment, a size of the radiator 110 or a parameter of the dielectric layer 120 may be adjusted to change an operating frequency band of the antenna structure. For example, the operating frequency band may cover some frequency bands in a GPS system, such as an L1 (1575.42 MHz±1.023 MHz) frequency band, an L2 (1227.60 MHz±1.023 MHz) frequency band, or an L5 (1176.45 MHz±1.023 MHz) frequency band in the GPS system. Alternatively, the operating frequency band may cover an N77 (3.3 GHz to 4.2 GHz) frequency band and an N79 (4.4 GHz to 5.0 GHz) frequency band in a 5G frequency band. For brevity of description, in this application, 0.8 GHz is used as a resonance frequency of the antenna structure. This is not limited in this application.

It should be understood that when operating frequency bands of the antenna structures are different, capacitance values of the first capacitive component 131 may be different.

For example, for a low frequency band (698 MHz to 960 MHz), a capacitance value of the first capacitive component 131 is between 1.5 pF and 15 pF, for example, 3 pF, 4 pF, or 5 pF.

For example, for an intermediate frequency band (1710 MHz to 2170 MHz), a capacitance value of the first capacitive component 131 is between 0.8 pF and 12 pF, for example, 1.5 pF, 1.8 pF, or 2 pF.

For example, for a high frequency band (2300 MHz to 2690 MHz), a capacitance value of the first capacitive component 131 is between 0.3 pF and 10 pF, for example, 0.3 pF, 0.5 pF, or 1 pF.

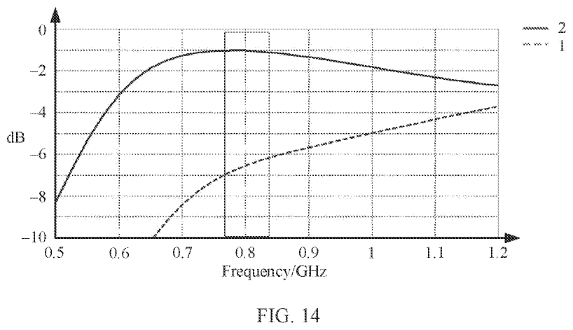

FIG. 14 is a diagram of a simulation result of radiation efficiency of the antenna structure shown in FIG. 12.

As shown in FIG. 14, a curve 1 of radiation efficiency corresponds to the antenna structure (for example, the antenna structure shown in FIG. 2) in the conventional technology, and a curve 2 of radiation efficiency corresponds to the antenna structure shown in FIG. 12. It should be understood that the antenna structure in the conventional technology has a same size as the antenna structure shown in FIG. 12, and a difference lies only in that the antenna structure shown in FIG. 12 is connected to a capacitive component in series at a tail end (an end at which a feed point is located is a head end) of the radiator.

As shown in FIG. 14, in a same antenna environment and under a same plastic particle loss condition (for example, DF=0.05 and DK=4.4), radiation efficiency of a new ILA structure provided in this embodiment of this application is obviously improved compared with that of the antenna structure in the conventional technology. For example, the radiation efficiency is approximately improved by 5.5 dB at 0.8 GHz.

It should be understood that the radiation efficiency of the new ILA structure provided in this embodiment of this application is improved because the new ILA structure more fully stimulates the ground of the electronic device. In this embodiment, 0.8 GHz is selected as a resonance frequency of the antenna structure, and a capacitance value of the capacitive component connected in series at the tail end of the radiator is 4.5 pF. Capacitance values of capacitive components connected in series in different embodiments may change. This depends mainly on an antenna environment at the tail end of the radiator. In addition, a slot formed between the radiator and the frame may form a distributed capacitor. Factors such as a slot width of the slot, areas of end faces on two sides of the slot, and plastic particles filled in the slot may affect a capacitance value of the distributed capacitor. Therefore, the capacitance value of the capacitive component connected in series may be determined based on the antenna environment at the tail end of the radiator.

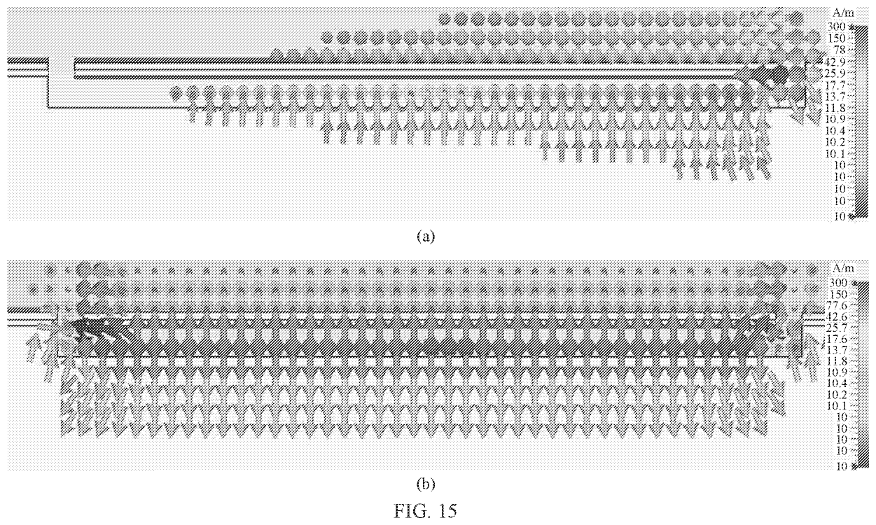

FIG. 15 is a diagram of a simulation result of a magnetic field of the antenna structure shown in FIG. 12.

The antenna structure corresponding to the conventional technology corresponds to (a) in FIG. 15, and the antenna structure shown in FIG. 12 corresponds to (b) in FIG. 15. It should be understood that the antenna structure in the conventional technology has a same size as the antenna structure shown in FIG. 12, and a difference lies only in that the antenna structure shown in FIG. 12 is connected to a capacitive component in series at a tail end of the radiator.

As shown in (a) in FIG. 15, in a conventional ILA structure, a head end (a feed end) of the radiator is a strong point of the magnetic field, and corresponds to a weak point of an electric field. The radiator is a resonant structure with a quarter operating wavelength. The tail end (a non-feed end) of the radiator is a weak point of the magnetic field, and corresponds to a strong point of the electric field. The magnetic field and the electric field of the radiator are not evenly distributed.

As shown in (b) in FIG. 15, in the antenna structure provided in this embodiment of this application, the radiator may be equivalent to an inductor. A capacitive component is connected to the tail end of the radiator in series, so as to cancel the inductor equivalent to the radiator. In addition, a loop may be formed between the radiator and the ground by using the capacitive component connected in series, to change an antenna environment at the tail end of the radiator, so that the tail end of the radiator is still the strong point of the magnetic field. In other words, a magnetic field between the radiator and the ground is evenly distributed and an amplitude of the magnetic field increases, and a corresponding electric field is evenly distributed and an amplitude of the electric field decreases. Therefore, for the antenna structure provided in this embodiment of this application, near-field electric field strength of the antenna structure is reduced and even, and radiation absorbed by plastic particles at a dielectric layer is reduced. Because impact of a dielectric loss of the plastic particles on radiation efficiency is reduced, radiation efficiency of the antenna structure can be effectively improved.

It should be understood that, in the antenna structure provided in this embodiment of this application, in a low frequency band, a capacitance value of the capacitive component connected to the tail end of the radiator in series is large, and is at a pF level. In addition, after the capacitive component is connected to the tail end of the radiator in series, the antenna structure may match impedance of a feed unit.

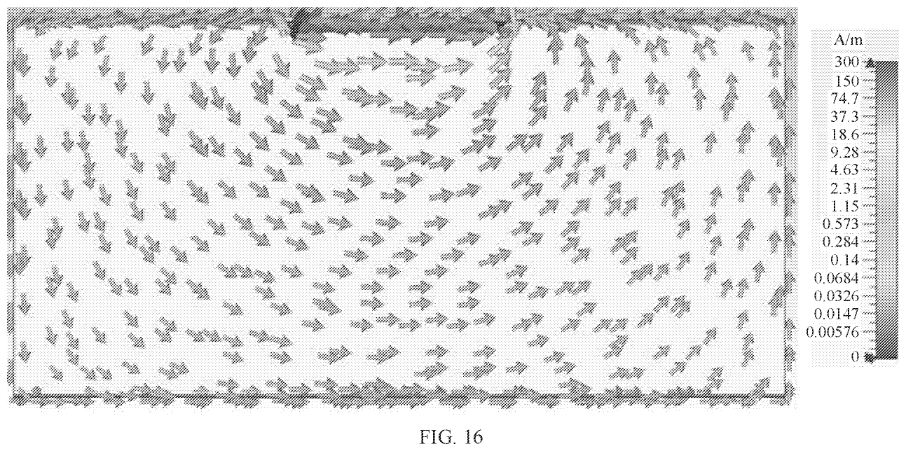

FIG. 16 is a diagram of a simulation result of current distribution of the antenna structure shown in FIG. 12.

As shown in FIG. 16, because a loop is formed between the radiator and the ground by using a capacitive component connected in series, a larger current on the ground is excited, to improve antenna radiation efficiency. It may alternatively be understood that when the antenna structure works, a first current on the radiator is distributed more evenly than a second current between the radiator and the ground when the antenna structure from which the first capacitive component is removed works. In addition, the current on the radiator is evenly distributed and has a large amplitude, a corresponding electric field is evenly distributed and has a small amplitude, and radiation absorbed by plastic particles at a dielectric layer is reduced. Because impact of a dielectric loss of the plastic particles on radiation efficiency is reduced, radiation efficiency of the antenna structure can be effectively improved.

FIG. 17 is a schematic diagram of an electronic device 10 according to an embodiment of this application. It should be understood that a structure of the electronic device shown in FIG. 17 is similar to a structure of the electronic device shown in FIG. 12, and a difference lies only in that a slot is provided on a radiator of the antenna structure shown in FIG. 17.

As shown in FIG. 17, the electronic device 10 may further include a second capacitive component 132, a third slot 143 may be further provided on the radiator 110, and the second capacitive component 132 may be connected to the radiator 110 in series at the third slot 143, that is, the second capacitive component 132 is electrically connected between radiator parts 110 on two sides of the third slot 143. One end of the second capacitive component 132 is connected to the radiator part on one side of the third slot 143, and the other end of the second capacitive component 132 is connected to the radiator part on the other side of the third slot 143.

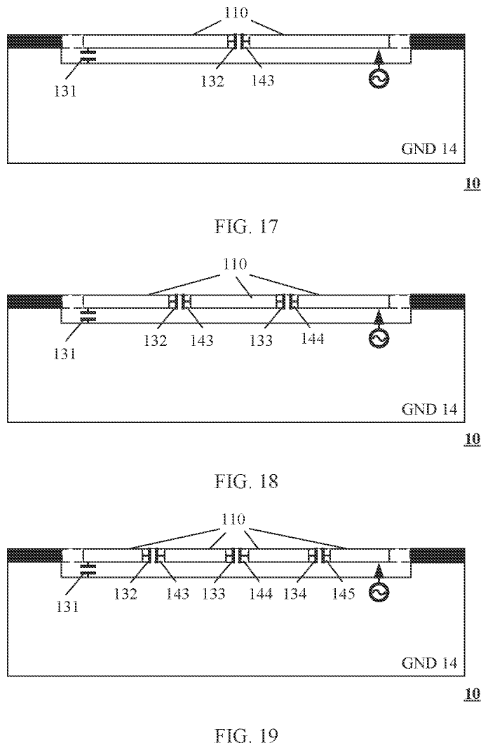

In the embodiment shown in FIG. 17, the electronic device 10 may further include a third capacitive component 133, a fourth slot 144 may be further provided on the radiator 110, and the third capacitive component 133 may be connected to the radiator 110 in series at the fourth slot 144, that is, the third capacitive component 133 is electrically connected between radiator parts 110 on two sides of the fourth slot 144. One end of the third capacitive component 133 is connected to the radiator part on one side of the fourth slot 144, and the other end of the third capacitive component 133 is connected to the radiator part on the other side of the fourth slot 144, as shown in FIG. 18.

In the embodiment shown in FIG. 18, the electronic device 10 may further include a fourth capacitive component 134, a fifth slot 145 may be further provided on the radiator 110, and the fourth capacitive component 134 may be connected to the radiator 110 in series at the fifth slot 145, that is, the fourth capacitive component 134 is electrically connected between radiator parts 110 on two sides of the fifth slot 145. One end of the fourth capacitive component 134 is connected to the radiator part on one side of the fifth slot 145, and the other end of the fourth capacitive component 134 is connected to the radiator part on the other side of the fifth slot 145, as shown in FIG. 19.

In an embodiment, the third slot 143, the fourth slot 144, and the fifth slot 145 may be distributed at equal spacings on the radiator 110, in other words, the third slot 143, the fourth slot 144, and the fifth slot 145 divide the radiator 110 into a plurality of parts, where lengths of the radiator parts may be equal. It should be understood that lengths of the radiator parts may be unequal, and may be adjusted based on an actual design or production requirement.

It should be understood that, if the first capacitive component 131 connected to the tail end of the radiator 110 in series is removed, and only the capacitive component connected to the radiator 110 in series is kept, the antenna structure can also obtain very high antenna radiation efficiency. In addition, this is a solution better than that in the conventional technology. Therefore, FIG. 12 and FIG. 17 to FIG. 19 show specific embodiments, and variations based on the embodiments also belong to the technical solutions of a new antenna provided in embodiments of this application. For example, if the first capacitive component additionally disposed at the tail end of the radiator shown in FIG. 12 moves from the tail end of the radiator to the head end of the radiator, this also belongs to the technical solution of the new antenna provided in embodiments of this application. In this case, high antenna radiation efficiency is also obtained, which is higher than that in the solution in the conventional technology.

In addition, capacitance values of the second capacitive component 132, the third capacitive component 133, and the fourth capacitive component 134 that are connected to the radiator 110 in series are different, and may be adjusted based on an actual production or design requirement. When the antenna structure works in different frequency bands, the second capacitive component 132 has different capacitance value ranges. For example, for a low frequency band (698 MHz to 960 MHz), a capacitance value of the second capacitive component 132 is between 2 pF and 15 pF. For an intermediate frequency band (1710 MHz to 2170 MHz), a capacitance value of the second capacitive component 132 is between 0.8 pF and 12 pF. For a high frequency band (2300 MHz to 2690 MHz), a capacitance value of the second capacitive component 132 is between 0.3 pF and 8 pF. In different operating frequency bands, capacitance value ranges of the third capacitive component 133 and the fourth capacitive component 134 may be the same as the capacitance value range of the second capacitive component 132, and capacitance values corresponding to the capacitive components may be different or may be the same.

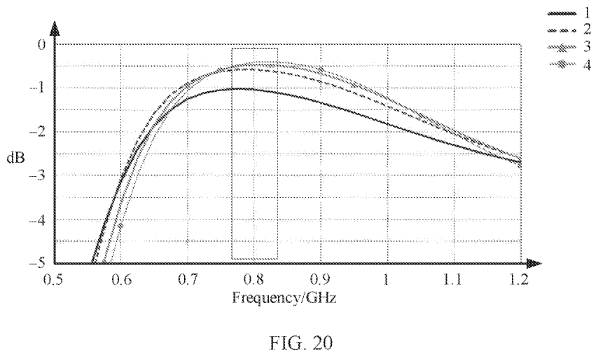

FIG. 20 is a diagram of a simulation result of radiation efficiency of antenna structures shown in FIG. 12, and FIG. 17 to FIG. 19.

As shown in FIG. 20, a curve 1 of radiation efficiency corresponds to the antenna structure shown in FIG. 12, a curve 2 of radiation efficiency corresponds to the antenna structure shown in FIG. 17, a curve 3 of radiation efficiency corresponds to the antenna structure shown in FIG. 18, and a curve 4 of radiation efficiency corresponds to the antenna structure shown in FIG. 19.

As shown in FIG. 20, as a quantity of capacitive components increases, the radiation efficiency of the antenna structure may be further improved. However, as a quantity of additionally disposed capacitive components increases, the radiation efficiency of the antenna structure is improved slightly, and the quantity of capacitive components may be adjusted based on an actual design or production requirement.

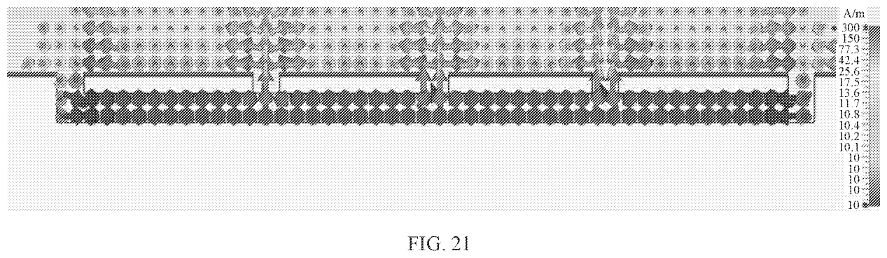

FIG. 21 is a diagram of a simulation result of a magnetic field of the antenna structure shown in FIG. 19.

Compared with the antenna structure shown in FIG. 12, the antenna structure shown in FIG. 19 is additionally provided with a plurality of slots and capacitive components that are connected at the slots in series on the antenna radiator. As shown in FIG. 21, compared with the antenna structure shown in FIG. 12, the antenna structure shown in FIG. 19 can cancel more inductors equivalent to the radiator, and change an antenna environment at a tail end of the radiator to a greater extent. Therefore, a magnetic field between the radiator and the ground is more evenly distributed, an amplitude of the magnetic field is larger, near-field electric field strength of the antenna structure is smaller, and radiation absorbed by plastic particles at a dielectric layer is less. This can further improve radiation efficiency of the antenna structure.

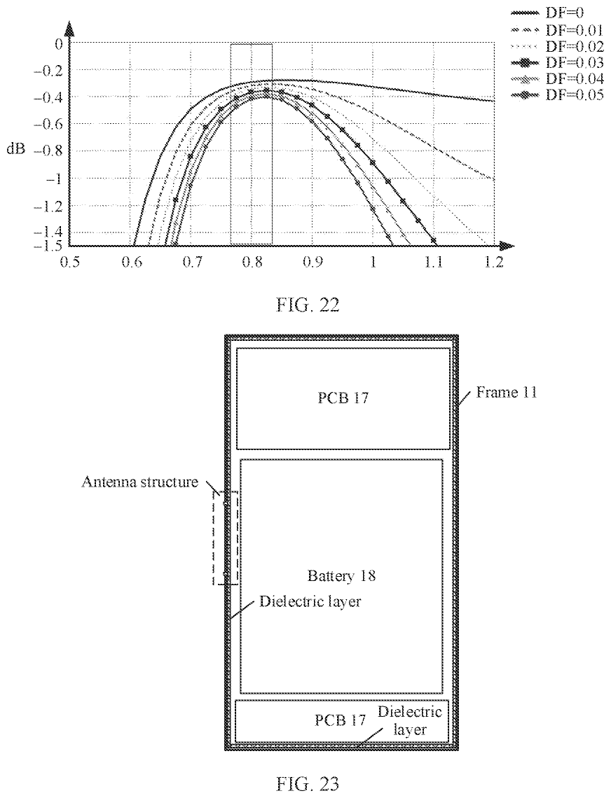

FIG. 22 is a diagram of a simulation result of radiation efficiency of the antenna structure shown in FIG. 19.

As shown in FIG. 22, DK values of plastic particles at a dielectric layer corresponding to all radiation efficiency curves are the same, and a difference lies only in dielectric losses of the plastic particles. A curve 1 of radiation efficiency corresponds to DF=0, namely, radiation efficiency corresponding to a case in which the plastic particles have no dielectric loss. A curve 2 of radiation efficiency corresponds to DF=0.01, a curve 3 of radiation efficiency corresponds to DF=0.02, a curve 4 of radiation efficiency corresponds to DF=0.03, a curve 5 of radiation efficiency corresponds to DF=0.04, and a curve 6 of radiation efficiency corresponds to DF=0.05.

As shown in FIG. 22, when the antenna structure is same, the new antenna structure provided in this embodiment of this application changes very little in radiation efficiency with a fluctuation range less than 0.2 dB at 0.8 GHz in a case in which the plastic particles have no loss, have a typical loss and have a large loss. For this result, it may be considered that the new antenna structure provided in this embodiment of this application is an antenna design that is not affected by the dielectric loss. Therefore, compared with the solution in the conventional technology, the new antenna structure can obtain higher antenna radiation efficiency in a same antenna environment and under a same plastic particle dielectric loss condition. In other words, in a case in which the current electronic device has an extremely small antenna clearance, compared with the existing solution, the new antenna structure provided in this embodiment of this application can obtain higher antenna radiation efficiency in same antenna space.

FIG. 23 is a schematic diagram of a structure of an electronic device according to an embodiment of this application.

As shown in FIG. 23, an antenna structure provided in this embodiment of this application may be disposed at a middle location of any side of a frame of the electronic device. The antenna structure is disposed at the location, and a ground in the antenna structure can be better excited, so that better radiation efficiency can be obtained.

It should be understood that the antenna structure provided in this embodiment of this application may alternatively be disposed at another location. This is not limited in this application, and may be adjusted based on an actual design or production requirement.

In an embodiment, the electronic device may further include another antenna structure, to meet a communication requirement. This is not limited in this application. It should be understood that a dielectric layer may be disposed on an inner side (close to a PCB 17 or a battery 18) of the frame 11, and another antenna structure is fastened in the electronic device, so that the another antenna structure and the frame or a housing form a complete mechanical part.

In the foregoing embodiment, an example in which a radiator antenna structure is an ILA is used for description. The technical solution provided in this embodiment of this application may also be used for an antenna structure in another form.

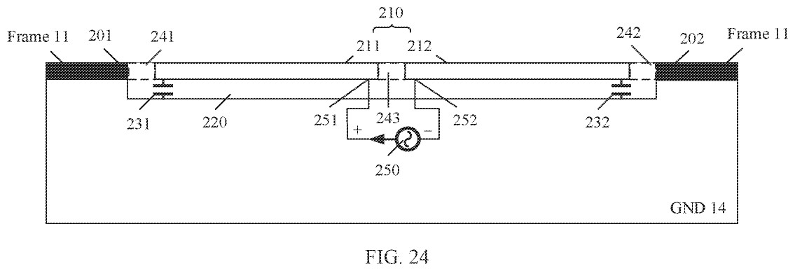

FIG. 24 is a schematic diagram of a structure of another electronic device according to an embodiment of this application.

As shown in FIG. 24, an electronic device 10 may include a frame 11, a ground 14, a feed unit 250, and an antenna structure. The antenna structure may include a radiator 210, a first capacitive component 231, and a second capacitive component 232.

The frame between a first location 201 and a second location 202 of the frame 11 is used as the radiator 210 of the antenna structure. The ground 14 is electrically connected to the frame 11. A first slot 241 is configured at the first location 201 of the frame 11. A second slot 242 is configured at the second location 202 of the frame 11. The first capacitive component 231 is electrically connected between a first end (the first end of the radiator 210 is an end that is of the radiator 210 and that is at the first slot 241) of the radiator 210 and the ground 14 (that is, an end of the first capacitive component 231 is grounded). The second capacitive component 232 is electrically connected between a second end (the second end of the radiator 210 is an end that is of the radiator 210 and that is at the second slot 242) of the radiator 210 and the ground 14 (that is, an end of the second capacitive component 232 is grounded). The radiator 210 may include a first radiator 211 and a second radiator 212. An end part of the first radiator 211 and an end part of the second radiator 212 are opposite to, but do not contact each other, and form a third slot 243. A first feed point 251 is disposed at an end, at the third slot 243, of the first radiator 211, and a second feed point 252 is disposed at an end, at the third slot 243, of the second radiator 212. The feed unit 250 is electrically connected to the radiator 210 at the first feed point 251 and the second feed point 252, and electrical signals of the feed unit 250 have a same amplitude but inverse phases (for example, a difference of 180° 10°) at the first feed point 251 and the second feed point 252, in other words, the feed unit 250 performs feeding for the radiator in an anti-symmetrical feeding (anti-symmetrical feeding) manner. In this case, the antenna structure including the radiator 210 may be used as an electrical dipole antenna.

It should be understood that the anti-symmetrical feeding may be implemented by using an anti-symmetrical circuit, an inverse coupler, or the like. This is not limited in this application.

In an embodiment, the electronic device 10 may further include a dielectric layer 220, and the dielectric layer 220 may be disposed between the radiator 210 and the ground 14, to improve strength of the antenna structure.

In an embodiment, the ground 14 may be electrically connected to the frame 11. Because the frame 11 is electrically connected to the ground 14, the first capacitive component 231 may alternatively be connected between the first location 201 of the frame 11 and the radiator 210 (the first capacitive component 231 is electrically connected between the first end of the radiator 210 and the frame 11) in series. Similarly, the second capacitive component 232 may alternatively be connected between the second location 201 of the frame 11 and the radiator 210 (the second capacitive component 232 is electrically connected between the second end of the radiator 210 and the frame 11) in series. In this case, same technical effect can be obtained.

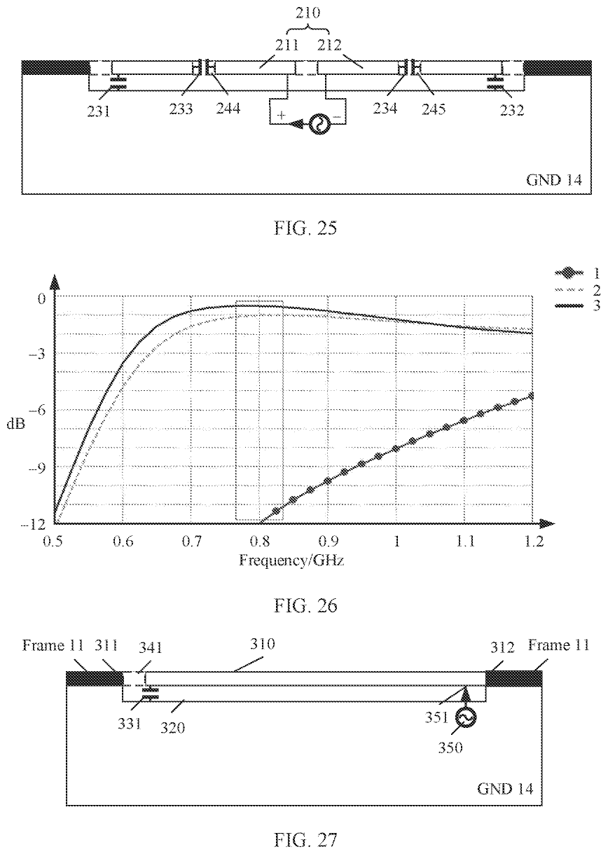

In the embodiment shown in FIG. 24, the electronic device may further include a third capacitive component 233 and a fourth capacitive component 234, and a fourth slot 244 and a fifth slot 245 may be further provided on the radiator 210. The third capacitive component 233 may be connected to the radiator 210 in series at the fourth slot 244, that is, the third capacitive component 233 is electrically connected between radiator parts 210 on two sides of the fourth slot 244. One end of the third capacitive component 233 is connected to the radiator part on one side of the fourth slot 244, and the other end of the third capacitive component 233 is connected to the radiator part on the other side of the fourth slot 244. The fourth capacitive component 234 may be connected to the radiator 210 in series at the fifth slot 245, that is, the fourth capacitive component 234 is electrically connected between radiator parts 210 on two sides of the fifth slot 245. One end of the fourth capacitive component 234 is connected to the radiator part on the one side of the fifth slot 245, and the other end of the fourth capacitive component 234 is connected to the radiator part on the other side of the fifth slot 245, as shown in FIG. 25.

In an embodiment, the third slot 243, the fourth slot 244, and the fifth slot 245 may be distributed at equal spacings on the radiator 210, in other words, the third slot 243, the fourth slot 244, and the fifth slot 245 divide the radiator 210 into a plurality of parts, where lengths of the radiator parts may be equal. It should be understood that the lengths of the radiator parts may be unequal, and may be adjusted based on an actual design or production requirement.

In addition, capacitance values of the third capacitive component 233 and the fourth capacitive component 234 that are connected to the radiator 210 in series are different, and may be adjusted based on an actual production or design requirement. When the antenna structure works in different frequency bands, the third capacitive component 233 has different capacitance value ranges. For example, for a low frequency band (698 MHz to 960 MHz), a capacitance value of the third capacitive component 233 is between 2 pF and 15 pF. For an intermediate frequency band (1710 MHz to 2170 MHz), a capacitance value of the third capacitive component 233 is between 0.8 pF and 12 pF. For a high frequency band (2300 MHz to 2690 MHz), a capacitance value of the third capacitive component 233 is between 0.3 pF and 8 pF. In different operating frequency bands, capacitance value ranges of the fourth capacitive component 234 may be the same as the capacitance value range of the third capacitive component 233, and capacitance values corresponding to the capacitive components may be different or may be the same.

FIG. 26 is a diagram of a simulation result of radiation efficiency of antenna structures shown in FIG. 24 and FIG. 25.

As shown in FIG. 26, a curve 1 of radiation efficiency corresponds to an electrical dipole structure (for example, the antenna structure shown in FIG. 6) in the conventional technology, a curve 2 of radiation efficiency corresponds to an antenna structure shown in FIG. 24, and a curve 3 of radiation efficiency corresponds to an antenna structure shown in FIG. 25. The antenna structure in the conventional technology has a same size as the antenna structures shown in FIG. 24 and FIG. 25, and a difference lies only in that the antenna structures shown in FIG. 24 and FIG. 25 include a capacitive component connected in series.

As shown in FIG. 26, in a same antenna environment and under a same plastic particle loss condition (for example, DF=0.05 and DK=4.4), radiation efficiency of a new ILA structure provided in this embodiment of this application is obviously improved compared with that of the antenna structure in the conventional technology. For example, the radiation efficiency is approximately improved by 0.5 dB at 0.8 GHz. In addition, as a quantity of capacitive components increases, the radiation efficiency of the antenna structure may be further improved. However, similar to the antenna structures shown in FIG. 17 to FIG. 19, in the antenna structure shown in FIG. 24, as the quantity of capacitive components connected to the radiator in series increases, the radiation efficiency of the antenna structure is improved slightly, and the quantity of capacitive components may be adjusted based on an actual design or production requirement.

FIG. 27 is a schematic diagram of a structure of another electronic device according to an embodiment of this application.

As shown in FIG. 27, the electronic device may include a frame 11, a ground 14, a feed unit 350, and an antenna structure. The antenna structure may include a radiator 310, and a first capacitive component 331.

The frame between a first location 311 and a second location 312 of the frame 11 is used as the radiator 310 of the antenna structure. A first slot 341 is configured at the first location 311 of the frame 11. The radiator 310 is connected to the frame 11 at the second location 202. The first capacitive component 331 is connected between a first end (the first end of the radiator 310 is an end that is of the radiator 310 and that is at the first slot 341) of the radiator 310 and the ground 14 (that is, an end of the first capacitive component 331 is grounded) in series. A feed point 351 is disposed at a second end (the second end of the radiator 310 is an end that is of the radiator 310 and that is at the second location) of the radiator 310, and the feed unit 350 is electrically connected to the radiator 310 at the feed point 351, to perform feeding for the radiator 310. The antenna structure including the radiator 310 may be used as an IFA

In an embodiment, the electronic device may further include a dielectric layer 320, and the dielectric layer 320 may be disposed between the radiator 310 and the ground 14, to improve strength of the antenna structure.

In an embodiment, the ground 14 may be electrically connected to the frame 11. Because the frame 11 is electrically connected to the ground 14, the first capacitive component 331 may also be connected between the first location 311 of the frame 11 and the radiator 310 (the first capacitive component 331 is electrically connected between the first end of the radiator 310 and the frame 11) in series, and same technical effect as that of the antenna structure shown in FIG. 27 may also be obtained.

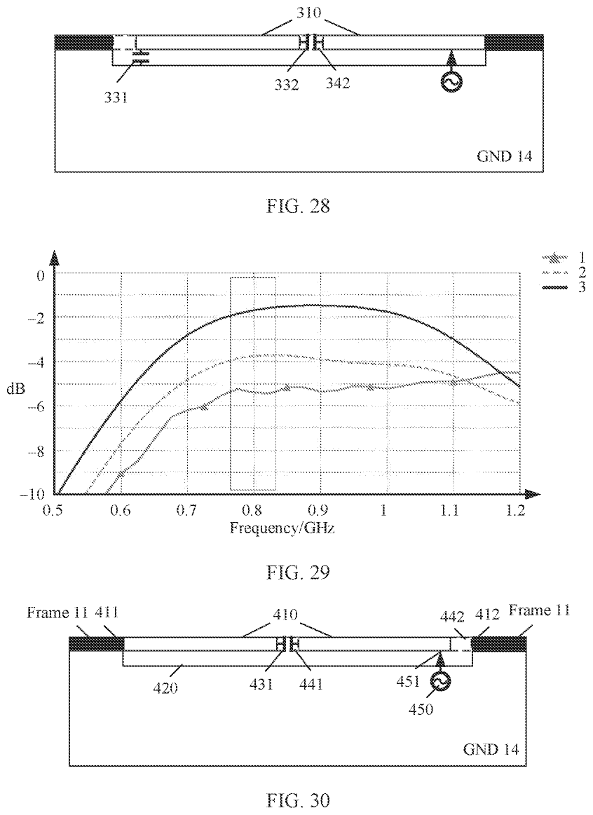

In the embodiment shown in FIG. 27, the electronic device may further include a second capacitive component 332, a second slot 342 may be further provided on the radiator 310, and the second capacitive component 332 may be connected to the radiator 310 in series at the second slot 342, that is, the second capacitive component 332 is electrically connected between radiator parts 210 on two sides of the second slot 342. One end of the second capacitive component 332 is connected to the radiator part on one side of the second slot 342, and the other end of the second capacitive component 332 is connected to the radiator part on the other side of the second slot 342, as shown in FIG. 28.

In an embodiment, the second slot 342 may be provided on the radiator 310 at equal spacings, that is, the second slot 342 divides the radiator 310 into two parts, where lengths of the radiator parts may be equal. It should be understood that the lengths of the radiator parts may be unequal, and may be adjusted based on an actual design or production requirement.

In addition, the second capacitive component 332 connected to the radiator 310 in series may be adjusted based on an actual production or design requirement. When the antenna structure works in different frequency bands, the second capacitive component 332 has different capacitance value ranges. For example, for a low frequency band (698 MHz to 960 MHz), a capacitance value of the second capacitive component 332 is between 2 pF and 15 pF. For an intermediate frequency band (1710 MHz to 2170 MHz), a capacitance value of the second capacitive component 332 is between 0.8 pF and 12 pF. For a high frequency band (2300 MHz to 2690 MHz), a capacitance value of the second capacitive component 332 is between 0.3 pF and 8 pF.

FIG. 29 is a diagram of a simulation result of radiation efficiency of antenna structures shown in FIG. 27 and FIG. 28.

As shown in FIG. 29, a curve 1 of radiation efficiency corresponds to an IFA structure (for example, the antenna structure shown in FIG. 4) in the conventional technology, a curve 2 of radiation efficiency corresponds to an antenna structure shown in FIG. 27, and a curve 3 of radiation efficiency corresponds to an antenna structure shown in FIG. 28. The antenna structure in the conventional technology has a same size as the antenna structures shown in FIG. 27 and FIG. 28, and a difference lies only in that the antenna structures shown in FIG. 27 and FIG. 28 include a capacitive component connected in series.

As shown in FIG. 29, in a same antenna environment and under a same plastic particle loss condition (for example, DF=0.05 and DK=4.4), radiation efficiency of a new ILA structure provided in this embodiment of this application is obviously improved compared with that of the antenna structure in the conventional technology. For example, the radiation efficiency is separately increased by 1.5 dB (for the antenna structure shown in FIG. 27) and 3.5 dB (for the antenna structure shown in FIG. 28) at 0.8 GHz. In addition, as a quantity of capacitive components increases, the radiation efficiency of the antenna structure may be further improved. However, similar to the antenna structures shown in FIG. 17 to FIG. 19, in the antenna structures shown in FIG. 27 and FIG. 28, as the quantity of capacitive components connected to the radiator in series increases, the radiation efficiency of the antenna structure is improved slightly, and the quantity of capacitive components may be adjusted based on an actual design or production requirement.

In the foregoing embodiment, an example in which a tail end of a radiator is open-circuited is used for description, for example, an ILA, an electrical dipole, or an IFA. The technical solutions provided in the embodiments of this application may also be used for an antenna structure in which a tail end of a radiator is short-circuited, for example, a CRLH or a slot antenna.

FIG. 30 is a schematic diagram of a structure of another electronic device according to an embodiment of this application.

As shown in FIG. 30, the electronic device may include a frame 11, a ground 14, a feed unit 450, and an antenna structure. The antenna structure may include a radiator 410, and a first capacitive component 431.

The frame between a first location 411 and a second location 412 of the frame 11 is used as the radiator 410. The radiator 410 is connected to the frame 11 at the first location 411, a feed point 451 is disposed on the radiator 410, and the feed unit 450 is electrically connected to the radiator 410 at the first feed point 411. A first slot 441 is provided on the radiator 410, the first slot 441 is located between the feed point 451 and the first location 411, and the first capacitive component 431 is electrically connected between radiator parts 410 on two sides of the first slot 441.

In an embodiment, the electronic device may further include a dielectric layer 420, and the dielectric layer 420 may be disposed between the radiator 410 and the ground 14, to improve strength of the antenna structure.

In an embodiment, a second slot 442 is configured at the second location 412 of the frame 11, the feed point 451 is disposed at a first end of the radiator 410, and the first end of the radiator 410 is an end that is of the radiator 410 and that is close to the second slot 442. The feed unit 450 performs feeding for the radiator 410 at the feed point 451. The radiator 410 may be used as a CRLH radiator.

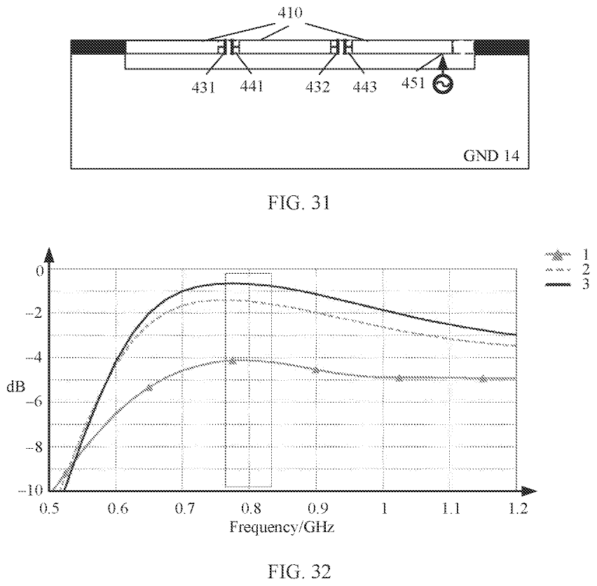

In an embodiment, the electronic device further includes a second capacitive component 432. A third slot 443 is provided on the radiator 410, and the third slot 443 is located between the feed point 451 and the first slot 441. The second capacitive component 432 is connected to the radiator 410 in series at the third slot 443, that is, the second capacitive component 432 is electrically connected between radiator parts 410 on two sides of the third slot 443, as shown in FIG. 31.

In an embodiment, the first slot 441 and the third slot 443 are distributed at equal spacings on the radiator 410, in other words, the first slot 441 and the third slot 443 divide the radiator 410 into a plurality of parts, where lengths of the radiator parts may be equal. It should be understood that the lengths of the radiator parts may be unequal, and may be adjusted based on an actual design or production requirement.

In addition, capacitance values of the first capacitive component 431 and the second capacitive component 432 that are connected to the radiator 410 in series are different, and may be adjusted based on an actual production or design requirement. When the antenna structure works in different frequency bands, the first capacitive component 431 has different capacitance value ranges. For example, for a low frequency band (698 MHz to 96 W MHz), a capacitance value of the first capacitive component 431 is between 2 pF and 15 pF. For an intermediate frequency band (1710 MHz to 2170 MHz), a capacitance value of the first capacitive component 431 is between 0.8 pF and 12 pF. For a high frequency band (2300 MHz to 2690 MHz), a capacitance value of the first capacitive component 431 is between 0.3 pF and 8 pF. In different operating frequency bands, capacitance value ranges of the second capacitive component 432 may be the same as the capacitance value range of the first capacitive component 431, and capacitance values corresponding to the capacitive components may be different or may be the same.

FIG. 32 is a diagram of a simulation result of radiation efficiency of antenna structures shown in FIG. 30 and FIG. 31.

As shown in FIG. 32, a curve 1 of radiation efficiency corresponds to a CRLH structure (for example, the antenna structure shown in FIG. 8) in the conventional technology, a curve 2 of radiation efficiency corresponds to an antenna structure shown in FIG. 30, and a curve 3 of radiation efficiency corresponds to an antenna structure shown in FIG. 31. The antenna structure in the conventional technology has a same size as the antenna structures shown in FIG. 30 and FIG. 31, and a difference lies only in that the antenna structures shown in FIG. 30 and FIG. 31 include a capacitive component connected in series.

As shown in FIG. 32, in a same antenna environment and under a same plastic particle loss condition (for example, DF=0.05 and DK=4.4), radiation efficiency of the new CRLH structure provided in this embodiment of this application is obviously improved compared with that of an antenna structure in the conventional technology. For example, the radiation efficiency is separately increased by 2.5 dB (for the antenna structure shown in FIG. 30) and 3.5 dB (for the antenna structure shown in FIG. 31) at 0.8 GHz. In addition, as a quantity of capacitive components increases, the radiation efficiency of the antenna structure may be further improved. However, similar to the antenna structures shown in FIG. 17 to FIG. 19, in the antenna structures shown in FIG. 30 and FIG. 31, as the quantity of capacitive components connected to the radiator in series increases, the radiation efficiency of the antenna structure is improved slightly, and the quantity of capacitive components may be adjusted based on an actual design or production requirement.

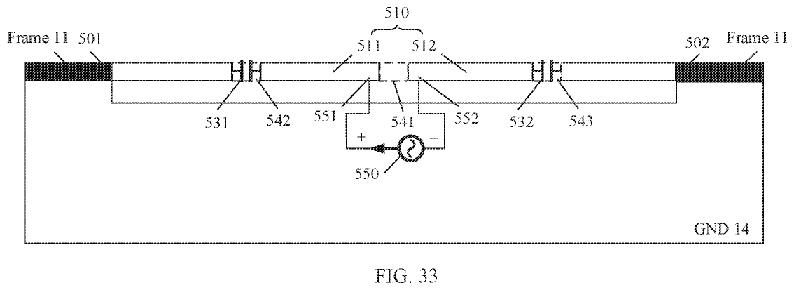

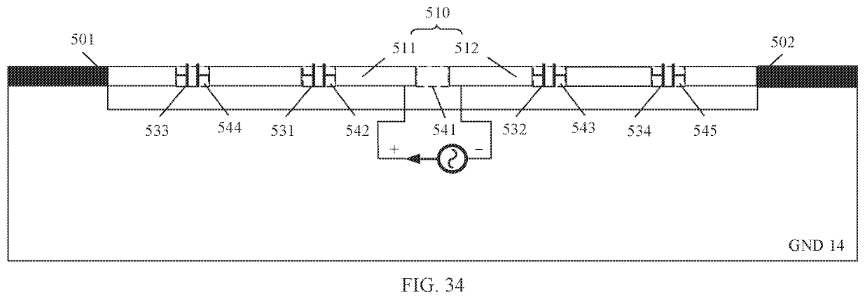

FIG. 33 is a schematic diagram of a structure of another electronic device according to an embodiment of this application.

As shown in FIG. 33, the electronic device may include a frame 11, a ground 14, a first capacitive component 531, a second capacitive component 532, and a feed unit 550.

The frame between a first location 501 and a second location 501 of the frame 11 is used as the radiator 510. The radiator 510 is connected to the frame 11 at the first location 501, and is connected to the frame 11 at the second location 502. The radiator 510 includes a first radiator 511 and a second radiator 512. An end part of the first radiator 511 and an end part of the second radiator 512 are opposite to, but do not contact each other, and form a first slot 541. A first feed point 551 and a second feed point 552 are further disposed on the radiator 510. The first feed point 551 is disposed at an end that is of the first radiator 511 and that is at the first slot 541, and the second feed point 552 is disposed at an end that is of the second radiator 512 and that is at the first slot 541. The feed unit 550 is electrically connected to the radiator 510 at the first feed point 551 and the second feed point 552. The feed unit 550 performs feeding for a slot antenna including the radiator 510 in an anti-symmetrical feeding manner. In other words, an electrical signal of the feed unit 550 has a same amplitude but inverse phases (for example, a difference of 180°±10°) at the first feed point 551 and the second feed point 55. A second slot 542 and a third slot 543 are provided on the radiator 510. The second slot 542 is provided on the first radiator 511, and is located between the first feed point 551 and the first location 501. The first capacitive component 531 is connected to the antenna radiator 510 in series at the second slot 542, that is, the first capacitive component 531 is electrically connected between radiator parts on two sides of the second slot 542. The third slot 543 is provided on the second radiator 512, and is located between the second feed point 552 and the second location 502. The second capacitive component 532 is connected to the antenna radiator 510 in series at the third slot 543, that is, the second capacitive component 532 is electrically connected between radiator parts on two sides of the third slot 543.

In an embodiment, the electronic device may further include a dielectric layer 520, and the dielectric layer 520 may be disposed between the radiator 510 and the ground 14, to improve strength of the antenna structure.

In the embodiment shown in FIG. 33, the electronic device further includes a third capacitive component 533 and a fourth capacitive component 534. A fourth slot 544 and a fifth slot 545 are provided on the radiator 510. The fourth slot 544 is provided on the first radiator 511, and is located between the second slot 542 and the first location 501. The third capacitive component 533 is connected to the antenna radiator 510 in series at the fourth slot 544, that is, two ends of the fourth slot 544 are respectively connected to the radiator parts on two sides of the fourth slot 544. The fifth slot 545 is provided on the second radiator 512, and is located between the third slot 543 and the second location 502. The fourth capacitive component 534 is connected to the antenna radiator 510 in series at the fifth slot 545, that is, two ends of the fourth capacitive component 534 are respectively connected to the radiator parts on two sides of the fifth slot 545, as shown in FIG. 34.

In addition, capacitance values of the third capacitive component 533 and the fourth capacitive component 534 that are connected to the radiator 210 in series are different, and may be adjusted based on an actual production or design requirement. When the antenna structure works in different frequency bands, the third capacitive component 533 has different capacitance value ranges. For example, for a low frequency band (698 MHz to 960 MHz), a capacitance value of the third capacitive component 533 is between 2 pF and 15 pF. For an intermediate frequency band (1710 MHz to 2170 MHz), a capacitance value of the third capacitive component 533 is between 0.8 pF and 12 pF. For a high frequency band (2300 MHz to 2690 MHz), a capacitance value of the third capacitive component 533 is between 0.3 pF and 8 pF. In different operating frequency bands, capacitance value ranges of the fourth capacitive component 534 may be the same as the capacitance value range of the third capacitive component 533, and capacitance values corresponding to the capacitive components may be different or may be the same.

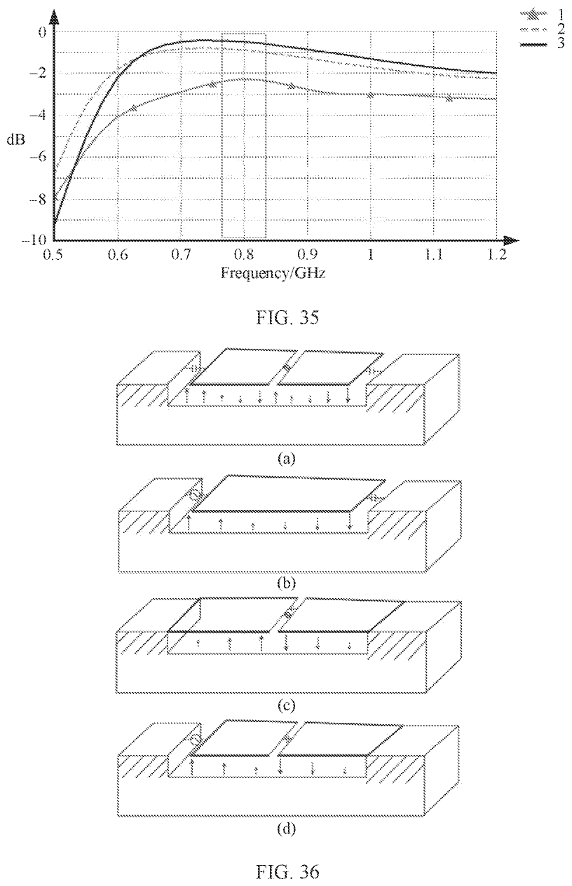

FIG. 35 is a diagram of a simulation result of radiation efficiency of antenna structures shown in FIG. 33 and FIG. 34.

As shown in FIG. 35, a curve 1 of radiation efficiency corresponds to a CRLH structure (for example, the antenna structure shown in FIG. 10) in the conventional technology, a curve 2 of radiation efficiency corresponds to an antenna structure shown in FIG. 33, and a curve 3 of radiation efficiency corresponds to an antenna structure shown in FIG. 34. The antenna structure in the conventional technology has a same size as the antenna structures shown in FIG. 33 and FIG. 34, and a difference lies only in that the antenna structures shown in FIG. 33 and FIG. 34 include a capacitive component connected in series.

As shown in FIG. 35, in a same antenna environment and under a same plastic particle loss condition (for example, DF=0.05 and DK=4.4), radiation efficiency of the new slot antenna structure provided in this embodiment of this application is obviously improved compared with that of an antenna structure in the conventional technology. For example, the radiation efficiency is separately increased by 1.2 dB (for the antenna structure shown in FIG. 33) and 1.7 dB (for the antenna structure shown in FIG. 34) at 0.8 GHz. In addition, as a quantity of capacitive components increases, the radiation efficiency of the antenna structure may be further improved. However, similar to the antenna structures shown in FIG. 17 to FIG. 19, in the antenna structures shown in FIG. 33 and FIG. 34, as the quantity of capacitive components connected to the radiator in series increases, the radiation efficiency of the antenna structure is improved slightly, and the quantity of capacitive components may be adjusted based on an actual design or production requirement.

In an embodiment, the new antenna structure provided in this embodiment of this application may be applied to a plurality of electronic devices with different metal frames, for example, an electronic device with a metal frame as an appearance, or an electronic device with plastic attached to an outer layer of a metal frame as an appearance. Alternatively, the new antenna structure may not only be a frame antenna of the electronic device, but may also be used in an antenna of another form, for example, a two-dimensional planar antenna (similar to a microstrip antenna). As shown in FIG. 36, the new antenna structure may also be used to improve radiation efficiency. Alternatively, the antenna structure may be a new type of antenna structure, or may be a laser-direct-structuring (laser-direct-structuring, LDS) antenna, a flexible printed circuit (flexible printed circuit, FPC) antenna, or a floating metal (floating metal, FLM) antenna, or may be a PCB antenna.

In the several embodiments provided in this application, it should be understood that the disclosed system, apparatus and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-20. (canceled)

21. An electronic device comprising:
a ground;
an antenna structure comprising:
a feed unit;
a radiator comprising:
a first end;
a second end; and
a first feed point disposed at the second end and electrically coupled to the feed unit;
a first capacitive component electrically coupled between the first end and the ground; and
a second capacitive component;
a frame comprising:
a first location; and
a second location, wherein the second end is at the second location; and
a section between the first location and the second location forming the radiator;
a first slot disposed at the first location, wherein the first end is at the first slot; and
a second slot disposed on the radiator and located between the first feed point and the first slot, wherein the second capacitive component is coupled to the radiator in series at the second slot.

22. The electronic device of claim 21, wherein an operating frequency band of the antenna structure is 698 megahertz (MHz) to 960 MHz and a capacitance value of the first capacitive component is between 1.5 picofarads (pF) and 15 pF, an operating frequency band of the antenna structure is 1710 MHz to 2170 MHz and a capacitance value of the first capacitive component is between 1.5 pF and 2 pF, or an operating frequency band of the antenna structure is 2300 MHz to 2690 MHz and a capacitance value of the first capacitive component is between 0.3 pF and 10 pF.

23. The electronic device of claim 21, wherein the radiator further comprises radiator parts located on two sides of the second slot, and wherein the radiator parts have a same length.

24. The electronic device of claim 21, wherein the first end is a radiator section comprising a first endpoint located at the first slot, wherein an electrical length of the radiator section is within one eighth of a first wavelength, and wherein the first wavelength corresponds to an operating frequency band of the antenna structure.

25. The electronic device of claim 21, further comprising a dielectric layer disposed between the radiator and the ground.

26. The electronic device of claim 21, wherein the electronic device is configured to generate a first magnetic field between the radiator and the ground when the antenna structure comprises the radiator and the first capacitive component, wherein the electronic device is configured to generate a second magnetic field between the radiator and the ground when the antenna structure does not comprise the first capacitive component, and wherein the first magnetic field is distributed more evenly than the second magnetic field.

27. The electronic device of claim 21, wherein the electronic device is configured to generate a first current on the radiator when the antenna structure comprises the radiator and the first capacitive component, wherein the electronic device is configured to generate a second current between the radiator and the ground when the antenna structure does not comprise the first capacitive component, and wherein the first current is distributed more evenly than the second current.

28. An electronic device comprising:
a ground;
a feed unit;
an antenna structure comprising:
a radiator comprising a first feed point that is disposed on the radiator and that is electrically coupled to the first feed point; and
a first capacitive component;
a frame comprising:
a first location; and
a second location;
a section between the first location and the second location forming the radiator; and
a first slot provided on the radiator and located between the first feed point and the first location, wherein the first capacitive component is coupled to the radiator in series at the first slot.

29. The electronic device of claim 28, wherein an operating frequency band of the antenna structure is 698 megahertz (MHz) to 960 MHz and a capacitance value of the first capacitive component is between 1.5 picofarads (pF) and 15 pF; an operating frequency band of the antenna structure is 1710 MHz to 2170 MHz and a capacitance value of the first capacitive component is between 1.5 pF and 2 pF, or an operating frequency band of the antenna structure is 2300 MHz to 2690 MHz and a capacitance value of the first capacitive component is between 0.3 pF and 10 pF.

30. The electronic device of claim 28, further comprising a second slot configured at the second location, wherein the radiator further comprises a first end located at the second slot, and wherein the first feed point is disposed at the first end.

31. The electronic device of claim 30, further comprising:
a third slot provided on the radiator, wherein the third slot is located between the first feed point and the first slot; and
a second capacitive component coupled to the radiator in series at the third slot.

32. The electronic device of claim 28, wherein the radiator is coupled to the second location and comprises:
a first radiator comprising:
a first end part; and
a first end; and
a second radiator comprising:
a second end part; and
a second end,
wherein the first end part is located opposite to the second end part without connecting to the second end part,
wherein the electronic device further comprises a second slot formed between the first end part and the second end part,
wherein the first feed point is disposed at the first end that is at the second slot,
wherein the radiator further comprises a second feed point disposed at the second end that is at the second slot,
wherein the feed unit is electrically coupled to the first feed point and the second feed point, and
wherein electrical signals of the feed unit at the first feed point and the second feed point have a same amplitude and inverse phases.

33. The electronic device of claim 32, further comprising:
a third slot provided on the radiator, wherein the third slot is located between the second feed point and the second location; and
a second capacitive component coupled to the radiator in series at the third slot.

34. The electronic device of claim 28, further comprising a dielectric layer disposed between the radiator and the ground.

35. An electronic device comprising:
a ground;
an antenna structure comprising:
a feed unit;
a radiator comprising:
a first end; and
a second end; and
a first capacitive component electrically coupled between the first end and the ground;
a frame comprising:
a first location;
a second location; and
a section between the first location and the second location forming the radiator;
a first slot configured at the first location, wherein the first end is located at the first slot;
a second slot configured at the second location, wherein the second end is located at the second slot; and
a first feed point disposed at the second end and electrically coupled to the feed unit.

36. The electronic device of claim 35, wherein an operating frequency band of the antenna structure is 698 megahertz (MHz) to 960 MHz and a capacitance value of the first capacitive component is between 1.5 picofarads (pF) and 15 pF, an operating frequency band of the antenna structure is 1710 MHz to 2170 MHz and a capacitance value of the first capacitive component is between 1.5 pF and 2 pF, or an operating frequency band of the antenna structure is 2300 MHz to 2690 MHz and a capacitance value of the first capacitive component is between 0.3 pF and 10 pF.

37. The electronic device of claim 35, further comprising:
a third slot provided on the radiator and located between the first feed point and the first slot; and
a second capacitive component coupled to the radiator in series at the third slot.

38. The electronic device of claim 37, wherein the radiator further comprises radiator parts located on two sides of the third slot, and wherein the radiator parts have a same length.

39. The electronic device of claim 35, wherein the first end is a radiator section comprising a first endpoint located at the first slot, wherein an electrical length of the radiator section is within one eighth of a first wavelength, and wherein the first wavelength corresponds to an operating frequency band of the antenna structure.

40. The electronic device of claim 35, further comprising a dielectric layer disposed between the radiator and the ground.
